(19) United States
(12) Patent Application Publication
(10) Pub. No.: US 2009/0045225 A1
(43) Pub. Date: Feb. 19, 2009

(54) Spray Gun

(76) Inventor: Josef Mikl, Salzburg (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/086,289

(22) PCT Filed: Dec. 7, 2006
(86) PCT No.: PCT/AT2006/000504

§ 371 Date: Jun. 10, 2008

(30) Foreign Application Priority Data
Dec. 15, 2005 (AT) A 2008/2005

(51) Int. Cl. B05B 7/04; B67D 5/56; B05B 7/24

(52) U.S. Cl. 222/135; 222/145.8; 222/145.5; 239/304; 239/310; 239/410

(57) ABSTRACT

The invention relates to a spray gun for generating a two-component foam, comprising two pressure vessels (2, 3) for accommodating the original components, ducts which are arranged parallel next to each other inside a gun member (1) in order to convey the original components, dosing valves for metering the original components, and a mixing chamber for producing the two-component foam. The dosing valves are embodied as needle valves, each of which is provided with a valve port that opens directly into a removable nozzle tip (4) inside which the mixing chamber is disposed. In order to create a simple structure while making the spray gun easy to clean, the connection points for the pressure vessels are placed one behind another in an axial direction while the pressure vessels (2, 3) are positioned substantially perpendicular to the gun member.

The invention relates to a spray gun for generating a two-component foam, comprising two pressure vessels for accommodating the starting components, ducts which are arranged parallel next to each other inside a gun member in order to convey the original components, dosing valves for metering the starting components, and a mixing chamber for producing the two-component foam, with the dosing valves being arranged as needle valves, each of which is provided with a valve port that opens directly into a removable nozzle tip inside which the mixing chamber is disposed.

It is known to use polyurethane foams in construction to join building elements and to produce insulations. Such foams can be produced in a cost-effective way and are easy to apply. One special advantage of the foams is that after the application they will swell in a predetermined manner, potential cavities are filled and a secure connection of the components is achieved. In practice, both single-component systems as well as two-component systems are used. The advantage of single-component systems is that only one single starting material is required and the apparatuses for application are simple and uncomplicated. The disadvantageous aspect in such systems is however that single-component foams will cure only by absorbing water from air humidity or from the adjacent building materials, so that the curing time is relatively long.

Two-component systems can be set in such a way that curing occurs very rapidly, so that a substantially faster progress in work can be achieved, since the components can be further processed virtually directly after gluing. Previously known apparatuses for producing and processing two-component foams are relatively complex however, so that such systems have not fully prevailed yet.

A spray gun for metering and mixing two starting components is known from U.S. Pat. No. 5,092,492 A with which a two-component foam can be produced. Metering occurs via a system of metering pistons, non-return valves and actuating members, thus leading overall to a relatively complex configuration.

Solutions are further known in which spray cans are used which are actuated through a common actuating apparatus in order to issue its content to a common nozzle. Such solutions are shown for example in U.S. Pat. No. 4,880,143 A, U.S. Pat. No. 5,634,571 A or U.S. Pat. No. 3,575,319 A. Although such apparatuses have a relatively simple configuration, they are not suitable for producing foam of high quality since the metering of the starting materials is not reproducible and the thorough mixture does not occur in a satisfactory manner.

US 2002/0038826 A shows a spray apparatus which is determined for connection to the feed tubes for the two components. Handling at the construction site is thus made more difficult. Moreover, the flow paths for the media are long, so that the quality of the mixture is unsatisfactory. Similar disadvantages apply to a solution as described in U.S. Pat. No. 6,158,624 A.

It is the object of the present invention to avoid these disadvantages and to provide a spray gun which has a simple configuration and is able to produce high-quality foam. An arrangement of the pressure vessels shall be achieved which is optimal for handling, both concerning the flow paths as well as the weight distribution of the apparatus.

It is a further object of the present invention to develop a spray gun which works reliably even under rough working conditions and is easy to clean and maintain.

This is achieved in accordance with the invention in such a way that the connection points for the pressure vessels are placed one behind another in an axial direction and that the pressure vessels are positioned substantially perpendicular to the gun member.

The relevant aspect in the invention is a simple arrangement and the fact that the starting components will meet only within a removable nozzle tip, so that curing of the work materials in the interior of the apparatus is prevented during work breaks. It has been noticed that directly actuated needle valves show considerable advantages over other valve systems such as check valves because in the case of non-appropriate use a blockage of the nozzle tip may occur, leading to a considerable counter-pressure. The needle tip enables securely preventing undesirable return flows of material from the nozzle tip to the conveying ducts, thus preventing blockage of or damage to the essential components of the spray gun. In such a case it is only necessary to replace the nozzle tip in order to bring about the functional state again. It is especially advantageous when the valve needles are pre-tensioned by springs in their closed position. The opening movement occurs in this case by a mechanical drive against the action of the spring. A predetermined closing force of the needle valves can thus be set.

An especially simple arrangement can be achieved in such a way that a common actuating apparatus is provided for both valve needles. An especially advantageous embodiment of the invention is characterized in that the valve needles are arranged in the interior of the conveying ducts. As a result, not only is a simple and compact configuration achieved, but it is also ensured that the conveying cross sections for the starting components have a simple and straight form, so that deposits of material and the like can be securely prevented. In this respect it is also important that the conveying ducts are arranged parallel next to one another and that the contact points for the pressure vessels are provided behind one another in the axial direction.

An especially simple configuration is also obtained in such a way that the nozzle tip comprises a flange which rests on the dosing valves, with the mixing chamber being arranged directly behind the flange. As a result, a functional spray gun is available after the exchange of the nozzle tip without having to perform any special cleaning work.

The production of the spray gun in accordance with the invention can be substantially simplified in such a way that the spray gun has a gun member in which conveying ducts are arranged and which is made as an injection-molded part. It is especially advantageous in this respect when said dosing valves are arranged as parts to be inserted in the gun member.

The present invention shall now be explained in closer detail by reference to embodiments shown in the drawings, wherein:

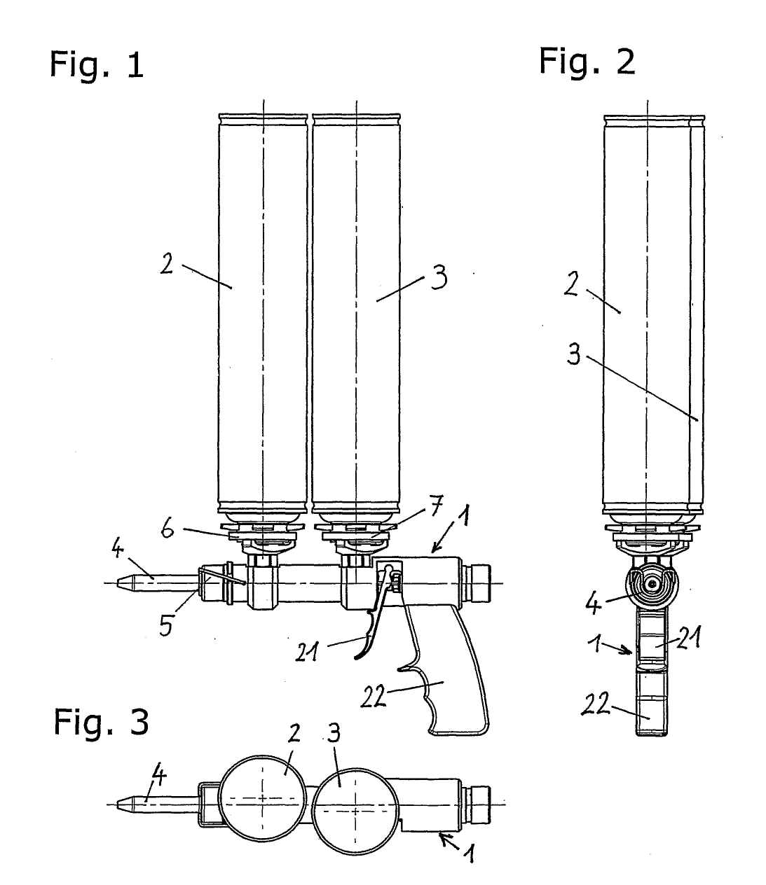

FIG. 1 shows a side view of an embodiment of the invention;

FIG. 2 shows a front view of the embodiment of FIG. 1;

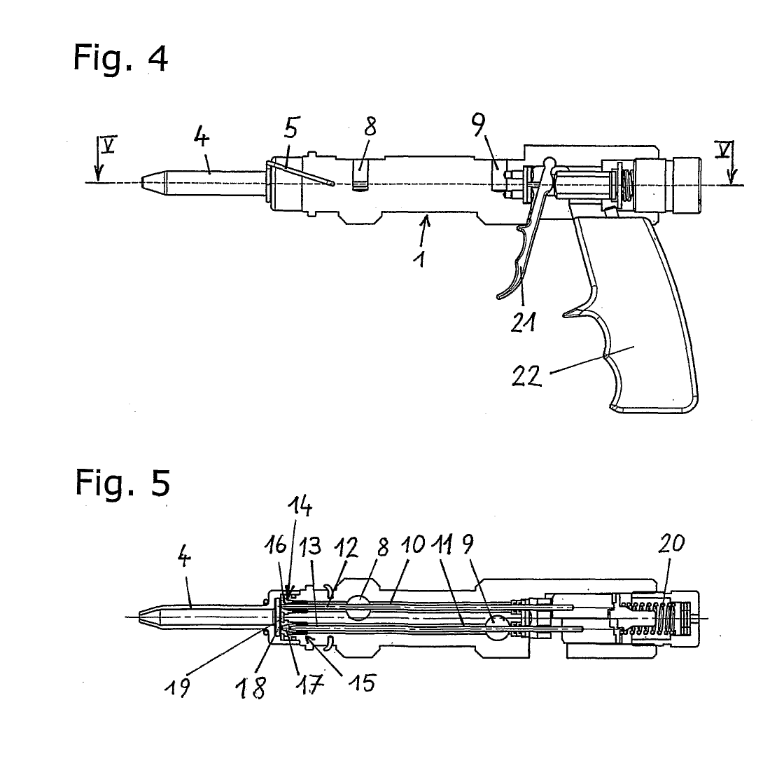

FIG. 3 shows a top view;

FIG. 4 shows a side view with removed pressure vessels on an enlarged scale, and

FIG. 5 shows a sectional view along line V-V in FIG. 4.

The spray gun in accordance with the invention consists of a gun member 1, on which two pressure vessels 2, 3 are mounted. A nozzle tip 4 is fastened in a removable manner with a clamp 5 in the front area of the gun member.

The pressure vessels 2, 3 are mounted via connection elements 6, 7 in the areas of bores 8, 9 in such a way that the connection points are offset against each other in the axial direction. The bores 8, 9 each open into conveying ducts 10, 11 which extend in the longitudinal direction of the gun member 1. Valve needles 12, 13 are movably arranged in the axial direction in the conveying ducts 10, 11, at the tips of which are provided the dosing valves 14, 15. Each dosing valve 14, 15 consists of a cone 16, 17 which opens towards the nozzle tip 4 and is covered by a flange 18 which is attached to the nozzle tip 4. A mixing chamber 19 is provided directly behind the flange 18, which chamber is used to mix the two components which are received by the pressure vessels 2, 3.

The valve needles 12, 13 are pre-tensioned by a spring 20 to the closed position. A trigger lever 21 in the area of the handle 22 of gun member 1 enables opening the dosing valves 14, 15 simultaneously.

The present invention allows producing spray guns which enable producing two-component foam in a simple way, are easy to clean and are convenient to handle.

1. A spray gun for generating a two-component foam, comprising two pressure vessels for accommodating the starting components, conveying ducts which are arranged parallel next to each other inside a gun member in order to convey the starting components, dosing valves for metering the starting components, and a mixing chamber for producing the two-component foam, with the dosing valves being arranged as needle valves, each of which is provided with a valve port that opens directly into a removable nozzle tip inside which the mixing chamber is disposed, wherein the connection points for the pressure vessels are placed one behind another in an axial direction and that the pressure vessels are positioned substantially perpendicular to the gun member.

2. A spray gun according to claim 1, wherein the valve needles are pre-tensioned in their closed position by at least one spring.

3. A spray gun according to claim 1, wherein a common actuating apparatus is provided for both valve needles.

4. A spray gun according to claim 1, wherein the valve needles are arranged in the interior of the conveying ducts.

5. A spray gun according to claim 1, wherein the nozzle tip comprises a flange which rests on the dosing valves, with the mixing chamber being arranged directly behind the flange.

6. A spray gun according to claim 1, wherein the spray gun has a gun member in which conveying ducts are arranged and which is made as an injection-molded part.

7. A spray gun according to claim 6, wherein the dosing valves are arranged as inserted parts in the gun member.
